(19) United States
(12) Patent Application Publication
(10) Pub. No.: US 2012/0268538 A1
(43) Pub. Date: Oct. 25, 2012

(54) PRINTING APPARATUS, PRINTING METHOD, AND PROGRAM

(75) Inventors: Takamitsu KONDO, Shiojiri-shi (JP); Toru TAKAHASHI, Azumino-shi (JP); Kazuyoshi TANASE, Matsumoto-shi (JP); Hiroshi WADA, Azumino-shi (JP)

(73) Assignee: SEIKO EPSON CORPORATION, Tokyo (JP)

(21) Appl. No.: 13/452,592

(22) Filed: Apr. 20, 2012

(30) Foreign Application Priority Data
Apr. 25, 2011 (JP) 2011-097395

(51) Int. Cl. B41J 2/01

(52) U.S. Cl. 347/102

(57) ABSTRACT

A printing apparatus is provided with an ink discharge nozzle which discharges photocurable ink which is cured when irradiated with light onto a medium, a surfactant nozzle which discharges a surfactant which has a substance which improves the wetting properties of the photocurable ink, and an irradiating section which irradiates the light onto the photocurable ink which has landed on the medium, wherein a process of discharging the surfactant from the surfactant nozzle onto the medium, a process of discharging the photocurable ink onto the medium, and a process of curing the photocurable ink by irradiating the light from the irradiating section are performed so that the surfactant is applied in the surroundings of the application range of the photocurable ink when an image is printed on the medium due to the application of the photocurable ink.

### BACKGROUND

1. Technical Field

The present invention relates to a printing apparatus, a printing method, and a program.

2. Related Art

A printing apparatus is known where photocurable ink (for example, UV ink) which is cured using irradiation of light (for example, ultraviolet (UV) light, visible light, or the like) is discharged. In a device such as this, light is irradiated onto a dot which has been formed on a medium after the UV ink has been discharged onto the medium from a nozzle. Due to this, the dot is cured and fixed to the medium (for example, refer to JP-A-2000-158793).

Since it is difficult for the photocurable ink to penetrate into the medium, when an image is printed using photocurable ink, for example, the dots which configure the printed image are formed to be raised compared to a case where an image is printed using ink with penetrating properties (for example, aqueous ink).

Furthermore, the inventors of the present application found a phenomenon (increased thickness phenomenon) where the edge periphery of the printed image is particularly raised more than other portions in a case where the image is printed in an ink jet method using photocurable ink. Then, when the printed image is visually recognized in a state where the light is mirror reflected in only a portion of the printed image with the increased thickness phenomenon as a cause, the printed image is seen three-dimensionally, the printed image is perceived as being thicker than in practice, and this is found to be a cause of deterioration in the image quality of the printed image.

### SUMMARY

Therefore, an advantage of some aspects of the invention is that image quality of an image which is printed with an ink jet method using photocurable ink is improved.

According to an aspect of the invention, there is provided a printing apparatus including an ink discharge nozzle which discharges photocurable ink which is cured when irradiated with light onto a medium, a surfactant nozzle which discharges a surfactant which has a substance which improves the wetting properties of the photocurable ink, and an irradiating section which irradiates the light onto the photocurable ink which has landed on the medium, wherein a process of discharging the surfactant from the surfactant nozzle onto the medium, a process of discharging the photocurable ink onto the medium, and a process of curing the photocurable ink by irradiating the light from the irradiating section are performed so that the surfactant is applied in the surroundings of the application range of the photocurable ink when an image is printed on the medium due to the application of the photocurable ink.

Other characteristics of the invention will be made clear through the specification and the description of the attached diagrams.

### BRIEF DESCRIPTION OF THE DRAWINGS

The invention will be described with reference to the accompanying drawings, wherein like numbers reference like elements.

FIG. 1A is an explanatory diagram of a printed image when an image is printed on a medium using UV ink.

FIG. 1B is a graph of measurement values of thickness in a region (edge periphery) which is shown by a dotted line in FIG. 1A.

FIG. 2A is a diagram where the printed image of FIG. 1A is viewed from above. FIG. 2B is an explanatory diagram of an appearance when light is mirror reflected at a portion of the printed image of FIG. 2A.

FIGS. 3A to 3C are explanatory diagrams of the concept of the embodiment. FIG. 3A is an explanatory diagram of the application range of surfactant. FIG. 3B is an explanatory diagram of a printed image and is an explanatory diagram of the application range of UV ink. FIG. 3C is an explanatory diagram of an appearance of dot formation due to the surfactant.

FIG. 4 is a block diagram of an overall configuration of a printer.

FIG. 5 is an explanatory diagram of an overall configuration of a printer.

FIG. 6 is an explanatory diagram of a test pattern.

FIG. 7 is an explanatory diagram of functions of a printer driver of a computer.

FIG. 8 is a flow diagram of a preprocessing image generation processing of FIG. 7.

FIGS. 9A to 9C are explanatory diagrams of image data. FIG. 9A is an explanatory diagram of image data after a half tone processing and is an explanatory diagram of image data for UV ink discharge. FIG. 9B is an explanatory diagram of an edge pixel. FIG. 9C is image data for preprocessing.

FIG. 10 is an explanatory diagram of another test pattern.

### DESCRIPTION OF EXEMPLARY EMBODIMENTS

At least the items below will be made clear due to the specifications and the description of the attached diagrams.

A printing apparatus will be made clear which is provided with an ink discharge nozzle which discharges photocurable ink which is cured when irradiated with light onto a medium, a surfactant nozzle which discharges a surfactant which has a substance which improves the wetting properties of the photocurable ink, and an irradiating section which irradiates the light onto the photocurable ink which has landed on the medium, wherein a process of discharging the surfactant from the surfactant nozzle onto the medium, a process of discharging the photocurable ink onto the medium, and a process of curing the photocurable ink by irradiating the light from the irradiating section are performed so that the surfactant is applied in the surroundings of the application range of the photocurable ink when an image is printed on the medium due to the application of the photocurable ink.

According to such a printing apparatus, it is possible to improve the image quality of an image which is printed with an ink jet method using photocurable ink.

It is desirable that the application range of the surfactant be determined according to the line width of the image. This is because, since the increased thickness phenomenon differs according to the line width, the application range which is appropriate for the surfactant is also different according to the line width of the image.

It is desirable that the width of the application range of the surfactant be determined according to the line width of the image. This is because the width which is appropriate for the application range of the surfactant is also different according to the line width of the image.

It is desirable that a test pattern be printed on the medium and the application range of the surfactant be determined according to the checking result of the test pattern. Due to this, it is possible to determine the application range which is appropriate for the surfactant.

It is desirable that the image be printed on the medium where there is no ink absorbing layer. This is particularly effective in a case where an image is printed with an ink jet method using photocurable ink with regard to a medium with no ink absorption in this manner.

A printing method will be made clear which uses an ink discharge nozzle which discharges photocurable ink which is cured when irradiated with light onto a medium, a surfactant nozzle which discharges a surfactant which has a substance which improves the wetting properties of the photocurable ink, and an irradiating section which irradiates the light onto the photocurable ink which has landed on the medium, wherein discharging the surfactant from the surfactant nozzle onto the medium, discharging the photocurable ink onto the medium, and curing the photocurable ink by irradiating the light from the irradiating section are performed so that the surfactant is applied in the surroundings of the application range of the photocurable ink when an image is printed on the medium due to the application of the photocurable ink.

According to the printing method such as this, it is possible to improve the image quality of an image which is printed with an ink jet method using photocurable ink.

A program will be made clear wherein discharging the surfactant from the surfactant nozzle onto the medium, discharging the photocurable ink onto the medium, and curing the photocurable ink by irradiating the light from the irradiating section are executed so that the surfactant is applied in the surroundings of the application range of the photocurable ink when an image is printed on the medium due to the application of the photocurable ink in a printing device which is provided with an ink discharge nozzle which discharges photocurable ink which is cured when irradiated with light onto a medium, a surfactant nozzle which discharges a surfactant which has a substance which improves the wetting properties of the photocurable ink, and an irradiating section which irradiates the light onto the photocurable ink which has landed on the medium.

According to the program such as this, it is possible to improve the image quality of an image which is printed with an ink jet method using photocurable ink.

### Concept

### Increased Thickness Phenomenon and Increased Thickness Feeling

Since a medium such as a plastic film has a substance where it is difficult to absorb ink, there is the using of UV ink as a photocurable ink when performing printing on a medium such as this using an ink jet method. The UV ink is an ink which contains a substance which is cured when irradiated with ultraviolet light. It is possible to perform printing even with regard to a medium with no ink absorption layer and with no ink absorbing properties due to dots being formed by curing of the UV ink.

However, since the dots which are formed using the UV ink bulge on the surface of the medium, convexities and concavities are possible on the surface of the medium when the printed image is formed on the medium using the UV ink. Then, the printed image has thickness in a case where the printed image is an image which covers the medium.

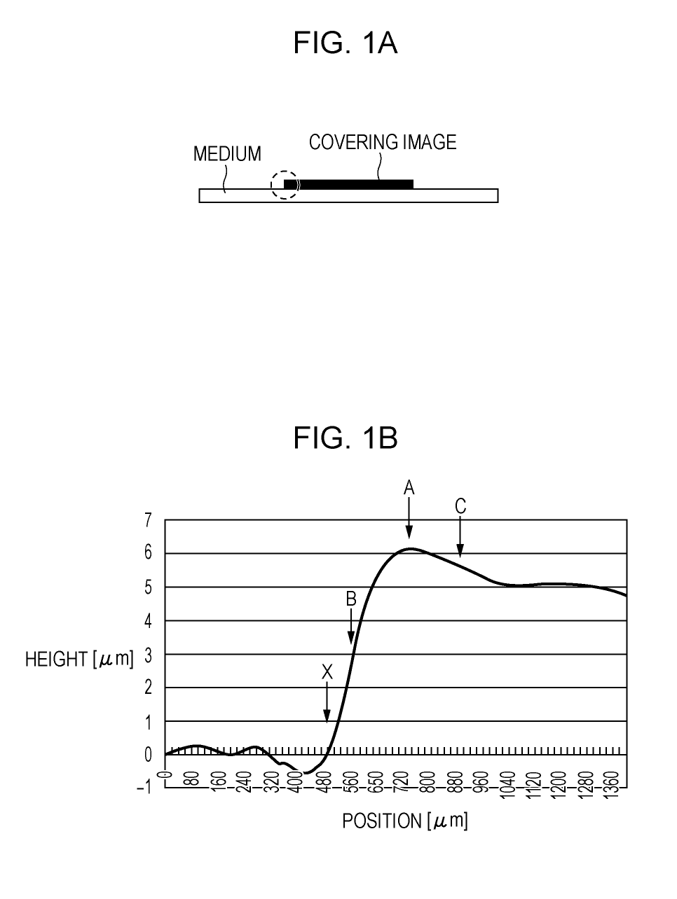

FIG. 1A is an explanatory diagram of a printed image when an image is printed on a medium using UV ink.

Since it is difficult for the UV ink to penetrate the medium, the dots are formed to be raised when the image is printed using the UV ink. When the image as a covering (covering image) is printed, the printed image which has thickness is formed on the medium since the dots which are formed using the UV ink bury a predetermined region. For example, in a case where a character is printed on the medium, a character image which has thickness (an example of a covering image) is formed on the medium. The thickness of the printed image which is printed using the UV ink is approximately several μm.

FIG. 1B is a graph of measurement values of thickness in a region (edge periphery) which is shown by a dotted line in FIG. 1A. The horizontal axis of the graph indicates the position of the medium and the vertical axis indicates the height of the dots (thickness of the printed image). Here, the printed image is an image where dots are formed with an ink amount of 10 ng and which covers with a printing resolution 720×720 dpi. The thickness of the printed image is measured using a non-stop CNC image measurement unit Quick Vision Streamplus manufactured by Mitutoyo Corporation. As shown in the diagram, the printed image has a thickness of approximately 5 μm.

A position X in the graph indicates a position which is the outermost side of the printed image. In other words, the position X indicates the position of the edge (contours) of the printed image. In addition, a position A in the graph indicates the thickest position (highest position) in the edge periphery of the printed image. In other words, the position A indicates the position of the bulging portion in the edge periphery of the printed image.

The position A is positioned at an inner side of approximately 200 μm from the position X. Between from the position X to the position A (a region B in the graph), there is an inclination so that the printed image is gradually thicker toward the inner side of the printed image. The vertical and horizontal scale in the graph do not match, but in practice, there is an inclination with an angle of less than 3° in the region B in the graph. In addition, in a region to the inner side of the position A in the printed image (a region C in the graph), the printed image is gradually thicker toward the inner side and is a substantially uniform thickness when the thickness reaches approximately 5 μm.

In the specification of the invention, the phenomenon where the edge periphery is particularly raised more than other portions is referred to as a “increased thickness phenomenon” as shown in the position A in the graph. The increased thickness phenomenon is a unique phenomenon which is generated when an image is printed with an ink jet method using the UV ink.

The mechanism which generates the increased thickness phenomenon is not clear, but it is considered to be as follows. The UV ink has fluidity to the extent that it is able to be discharged from the nozzle with an ink jet method although the viscosity is high compared to ink with penetrating properties (in this manner, the point where fluidity is necessary to the extent that discharge is possible from the nozzle is a unique attribute which is different from ink which is used in press printing). The UV ink has fluidity until completely cured by irradiating ultraviolet rays after having landed on the medium. It is considered that the increased thickness phenomenon is generated in the edge periphery of the printed image due to the effect of the fluidity after landing.

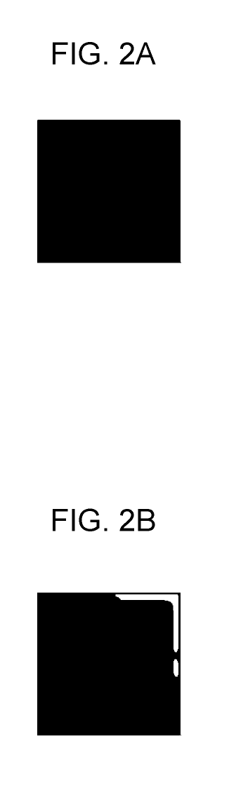

FIG. 2A is a diagram where the printed image of FIG. 1A is viewed from above. FIG. 2B is an explanatory diagram of an appearance when light is mirror reflected at a portion of the printed image of FIG. 2A. A portion which is visually recognized due to shining at an inner side of the printed image is shown as white in FIG. 2B.

In the central portion of the printed image, since the thickness is substantially the same, uniform glossiness is obtained. However, in the edge periphery of the printed image, since the thickness is not the same, uniform glossiness is not obtained.

In the edge periphery, the printed image does not have a uniform thickness and a bulging portion along the edge is formed along an inner side of the edge (contours) of the printed image due to the increased thickness phenomenon. As a result, there is visual recognition of a portion of the printed image shining at the edge as shown in FIG. 2B due to the state of the reflection angle of light. Due to the positional relationship and angle of the eyes of an observer, a light source, and the printed image, light which is mirror reflected at the inclined region in FIG. 1B enters the eyes of the observer and the printed image is visually recognized as shown in FIG. 2B.

As shown in FIG. 2B, when a portion of the printed image is viewed as shining along the edge, the entire printed image is perceived as three-dimensional. As an example, the printed image is perceived as three dimensional as when a three-dimensional object is displayed by the illumination of a portion of an object as a two-dimensional image being brighter in a display using computer graphics (for example, as when a three-dimensional object is displayed as a two-dimensional image using a ray tracing method). As a result, irrespective of there being a thickness of approximately 5 μm in practice, the observer of the printed image perceives a thickness equal to or more than this.

In the specifications, the perception that the printed image is thicker than in practice due to the increased thickness phenomenon is referred to as a “increased thickness feeling”. The issue of the “increased thickness feeling” is a unique issue which is generated when an image is printed with the ink jet method using the UV ink.

Here, there is hardly any thickness in the printed image according to normal press printing (such as flexography or offset printing) compared to the printed image using the UV ink. As a result, in the printed image according to the normal press printing, the “increased thickness phenomenon” is not generated and the issue of the “increased thickness feeling” does not occur. In addition, also in the printed image which is printed by ink penetrating the medium, there is any hardly thickness in the printed image. As a result, also in the printed image which is printed by ink penetrating the medium, the “increased thickness phenomenon” is not generated and the issue of the “increased thickness feeling” does not occur. In this manner, the increased thickness phenomenon and the increased thickness feeling are a unique phenomenon and issue which are generated when an image is printed with an ink jet method using the UV ink.

### CONCEPT OF EMBODIMENT

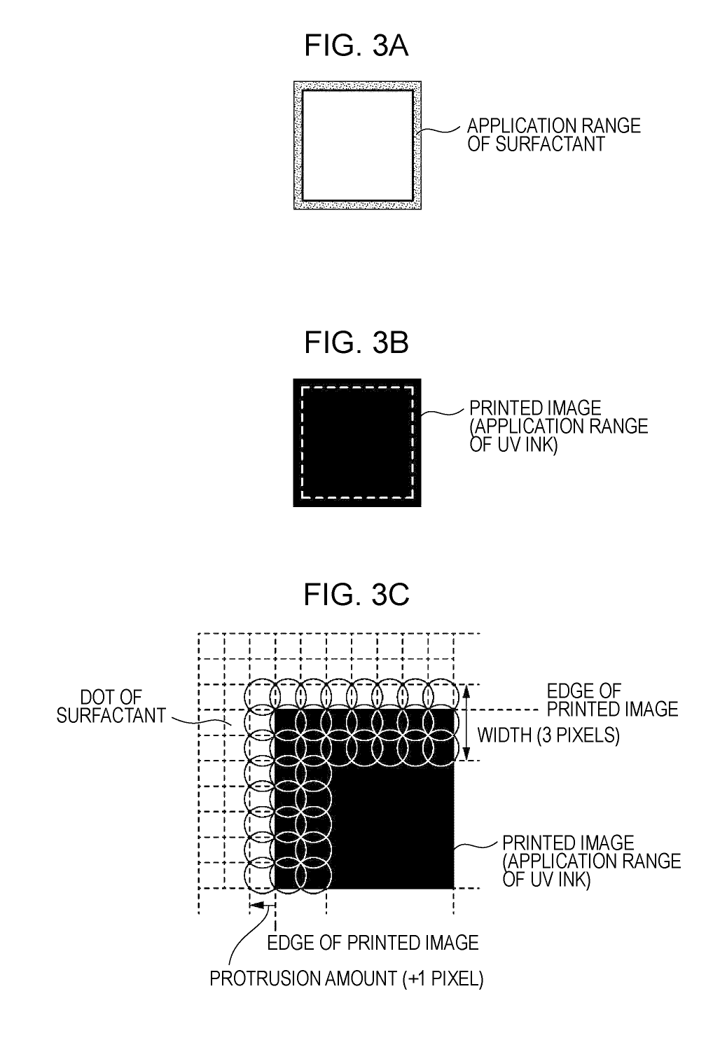

FIGS. 3A to 3C are explanatory diagrams of the concept of the embodiment. FIG. 3A is an explanatory diagram of the application range of surfactant. FIG. 3B is an explanatory diagram of a printed image and is an explanatory diagram of the application range of UV ink. FIG. 3C is an explanatory diagram of an appearance of dot formation due to the surfactant.

In the embodiment, a surfactant (surface active agent) is applied to the surrounding of the printed image. In other words, the surfactant is applied along the edge of the printed image in the embodiment. Due to this, it is easier for the UV ink to be wet and spread out in the surroundings of the printed image and the condensation of the UV ink in the surroundings of the printed image is suppressed. As a result, it is possible to suppress the increased thickness phenomenon in the embodiment.

Here, the width of the application range of the surfactant is three pixels in FIG. 3C. In addition, the protrusion amount of the application range of the surfactant with regard to the edge of the printed image is one pixel. The width and the protrusion amount of the application range are not limited to these values. In addition, the protrusion amount of the application range of the surfactant may be a minus value. In a case where the protrusion amount is negative, the application range of the surfactant is positioned at an inner side of the printed image. As a result, the “surroundings of the printed image” is not limited to the outer periphery of the printed image, and in addition, is not limited to the inner periphery of the printed image, but has the meaning of at least either the outer periphery or the inner periphery of the printed image. The width and the protrusion amount of the application range of the surfactant are determined as appropriate values using a checking process which will be described later.

### Basic Configuration

First, a basic configuration of the printing apparatus will be described. Here, the “printing apparatus” of the embodiment is an apparatus for printing an image on a medium while applying a surfactant. For example, an apparatus (system) which is configured from a printer 1 which will be described below and a computer 110 where a printer driver is installed is equivalent to the printing apparatus. Then, a controller 10 of the printer 1 and the computer 110 configures a control section for controlling the printing apparatus.

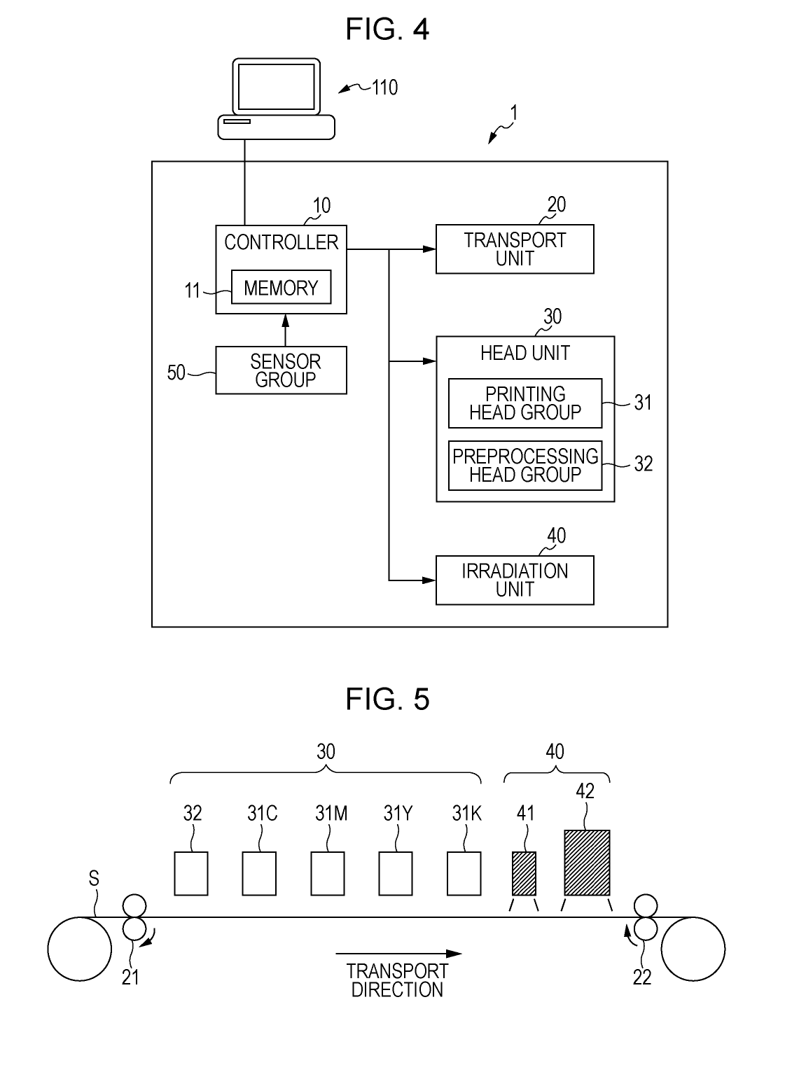

FIG. 4 is a block diagram of an overall configuration of the printer 1. FIG. 5 is an explanatory diagram of an overall configuration of the printer 1. The printer 1 of the embodiment is a so-called line printer. Here, the printer 1 may not be a line printer and may be a so-called serial printer (a printer where a head is mounted on a carriage which is able to move in the paper width direction).

The printer 1 has the controller 10, a transport unit 20, a head unit 30, an irradiation unit 40, and a sensor group 50. The printer 1 which receives printing data from the computer 110 which is a printing control device controls each of the units (the transport unit 20, the head unit 30, the irradiation unit 40, and the like) using the controller 10.

The controller 10 is a control device for performing control of the printer 1. The controller 10 controls each of the units according to a program which is stored in a memory 11. In addition, the controller 10 controls each of the units based on printing data which is received from the computer 110 and prints an image on a medium S. In addition, various types of detection signals which are detected by the sensor group 50 are input into the controller 10.

The transport unit 20 is for transporting the medium S (for example, paper, film, or the like) in the transport direction. The transport unit 20 has a transport motor (not shown), an upstream roller 21, and a downstream roller 22. When the transport motor which is not shown is rotated, the upstream roller 21 and the downstream roller 22 rotate and the medium S in a rolled up form is transported in the transport direction.

The head unit 30 is for discharging a liquid (ink, surfactant, or the like) onto the medium S. The head unit has a printing head group 31 and a preprocessing head group 32. The printing head group 31 is for discharging ink for forming an image into the medium. As the printing head group 31, a cyan head group 31C which discharges cyan ink, a magenta head group 31M which discharges magenta ink, a yellow head group 31Y which discharges yellow ink, and a black head group 31K which discharges black ink are provided.

The preprocessing head group 32 is for discharging the surfactant onto the medium. In the embodiment, the surfactant is applied in the surroundings of the printed image as preprocessing and the preprocessing head group 32 is for discharging the surfactant for carrying out the preprocessing on the medium. The preprocessing head group 32 is provided further to the upstream side of the transport direction than the printing head group 31.

Each of the head groups (the printing head group 31 and the preprocessing head group 32) is provided with a plurality of heads which are lined up in a paper width direction (a direction which is orthogonal to the paper surface in FIG. 5) and each of the heads is provided with a plurality of nozzles which are lined up in the paper width direction. Due to this, each of the head groups is able to form dots for the width of the paper at one time. When the ink is discharged from the printing head group 31 toward the medium S during transport, the printed image is formed in two dimensions on the printing surface of the medium S. In addition, when the surfactant is discharged from the preprocessing head group 32 toward the medium S during transport, it is possible to carry out the preprocessing on the printing surface of the medium S.

In the embodiments, the UV ink is discharged from each of the nozzles of the printing head group 31. The UV ink is ink which has an attribute of being cured when irradiated with ultraviolet light. Here, the UV ink has an attribute of high viscosity compared to ink with penetrating properties for performing printing by penetrating the medium. As a result, even in a case where it is assumed that printing is performed on normal paper, it is difficult for the UV ink to be absorbed by the medium compared to ink with penetrating properties. Since the UV ink is fixed to the medium by the dots being cured, it is possible to perform printing even with a medium where it is assumed that there is no ink absorption layer and no absorption. Here, it is possible to adopt an ink which is disclosed, for example, in JP-A-2006-199924 as the UV ink and other UV inks may be used.

In addition, in the embodiment, the surfactant, which has an attribute where the wetting properties of the UV ink are improved, is discharged from each of the nozzles of the preprocessing head group 32. As the surfactant which has an attribute where the wetting properties of the UV ink are improved, for example, there is a liquid where LHP-90, which is an oil repentant inhibitor which is manufactured by Kusumoto Chemicals Ltd., has been diluted 100 times (is used by being diluted so as to be able to be discharged from the nozzles).

The irradiation unit 40 is for irradiating the ultraviolet light onto the UV ink which has been discharged onto the medium S. The irradiation unit 40 has a provisional curing irradiation section 41 and a main curing irradiation section 42.

The provisional curing irradiation section 41 is provided in a downstream side of the printing region in the transport direction (the downstream side of the head unit 30 in the transport direction). The provisional curing irradiation section 41 irradiates the ultraviolet light with intensity to the extent that the surface of the UV ink is cured (provisionally cured) so that the UV inks which have landed on the medium S do not bleed. For example, an LED (light emitting diode) or the like is adopted as the provisional curing irradiation section 41.

Here, in the embodiment, one provisional curing irradiation section is provided on the downstream side of the head unit 30 in the transport direction, but the provisional curing irradiation sections may be provided on the downstream side of each of the head groups of the four colors in the transport direction.

The main curing irradiation section 42 is provided on the downstream side of the provisional curing irradiation section 41 in the transport direction. The main curing irradiation section 42 irradiates the ultraviolet light with intensity so that the UV ink on the medium is able to be completely cured (completely fixed). For example, a UV lamp or the like may be adopted as the main curing irradiation section 42.

When printing is performed, the controller 10 makes the transport unit 20 transport the medium S in the transport direction. Then, the controller 10 carries out preprocessing on the printing surface of the medium S by discharging the surfactant from the preprocessing head group 32 while transporting the medium S. Then, the controller 10 applies the UV ink by the UV ink being discharged from the printing head group 31 while transporting the medium S, dots which are formed using the UV ink are provisionally cured by the ultraviolet light being irradiated from the provisional curing irradiation section 41, and the dots are completely cured by the ultraviolet light being irradiated from the main curing irradiation section 42. Then, the controller 10 winds the medium S where the printed image has been printed at the downstream side of the downstream roller 22 in the transport direction.

The computer 110 is connected so as to be able to communicate with the printer 1 and the printing data is output from the printer 1 according to the image which is printed since the image is printed by the printer 1.

The printer driver is installed in the computer 110. The printer driver is a program for converting image data which has been output from an application program into printing data. The printer driver is recorded on a recording medium (a recording medium which is able to be read by a computer) such as a CD-ROM. The printer driver is able to be downloaded to the computer 110 via the Internet. Preprocessing (Application of Surfactant)

### Checking Process

Before performing the printing, it is necessary that the width and the protruding amount of the application range of the surfactant is determined in advance. Therefore, test patterns where each of the width and the protrusion amount of the application range of the surfactant differ are printed by the printer 1. By selecting the test pattern with the optimal image quality from among these, the width and the protrusion amount of the application range of the surfactant which are appropriate for the preprocessing are determined.

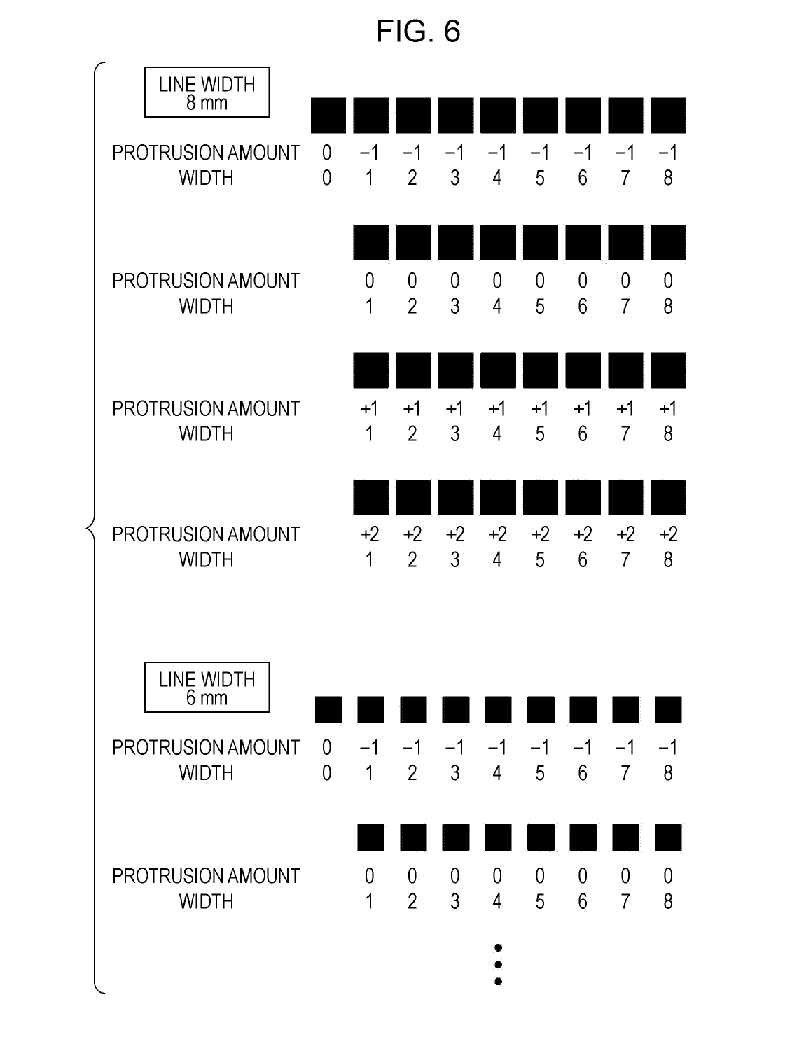

FIG. 6 is an explanatory diagram of a test pattern. The printer 1 prints a plurality of test patterns on the medium as shown in the diagram.

Each of the test patterns are configured from a rectangular pattern, a display of the width of the application range of the surfactant, and a display of the protrusion amount of the application range of the surfactant (in detail, the protrusion amount of the application range of the surfactant with regard to the edge of the printed image). Although not shown, preprocessing is carried out on the rectangular pattern. That is, the rectangular pattern is formed with the UV ink after the surfactant has been applied to a location which is the surroundings of the rectangular pattern. The width and the protrusion amount of the application range of the surfactant with regard to the rectangular pattern are as per each of the numbers which are displayed at the bottom of the rectangular pattern.

The rectangular pattern in the upper left in the diagram (the rectangular pattern where the width of the application range of the surfactant and the protrusion amount of the application range of the surfactant are zero) is the covering image printed as it is. That is, preprocessing is not carried out in the rectangular pattern in the upper left. Normally, the increased thickness phenomenon occurs in the rectangular pattern in the upper left and the rectangular pattern in the upper left is perceived as thicker than the actual thickness.

In the rectangular pattern to the right side of the diagram, the width of the application range of the surfactant is thicker.

When the width of the application range of the surfactant is too thin, the UV ink does not sufficiently wet and spread out and there is a concern that it is not possible to suppress the increased thickness phenomenon very much. In this case, glossiness along the edge is visually recognized at the inner side of the rectangular pattern and there is a concern that the increased thickness feeling remains. It is not able to be said that the width of the application range of the surfactant in the rectangular pattern where the increased thickness feeling remains in this manner is optimal. On the other hand, when the width of the application range of the surfactant is too thick, although not shown, the edge of the rectangular pattern is visually recognized as having bled. It is not able to be said that the width of the application range of the surfactant in the rectangular pattern such as this is optimal since the image quality deteriorates. Due to reasons such as these, the plurality of test patterns where the width of the application range of the surfactant is changed is formed.

In addition, the protrusion amount of the application range of the surfactant differs in the rectangular patterns in the upper and lower of the diagram. This is because it is considered that the degree of suppression of the increased thickness phenomenon is different according to the position of the application range of the surfactant with regard to the edge of the printed image even if, for example, the width of the application range of the surfactant is the same. Due to reasons such as these, the plurality of test patterns where the protrusion amount of the application range of the surfactant is changed is formed.

In addition, the test patterns are each formed with differing line widths. For example, the test pattern in the fourth row in the upper side of the diagram are rectangular patterns with an 8 mm angle, but the rectangular patterns with a 6 mm angle are also formed in the lower side of the diagram. This is because it is considered that the optimal values of the width and the protrusion amount of the application range of the surfactant differ according to the line width. For example, since the amount of ink which is applied to the medium in a case where the line width is thin is low, the increased thickness phenomenon is small compared to a case where the line width is thick and it is considered that it is possible for the width of the application range of the surfactant to be made to be thin. Due to reasons such as these, the plurality of test patterns where the line widths are different is formed.

A checker observes each of the rectangular patterns and selects the rectangular pattern with no increased thickness feeling and no bleeding. That is, the checker observes both the “glossiness” and the “color” of the rectangular pattern and selects the optimal rectangular pattern. If there is a plurality of line width test patterns, the checker selects the optimal rectangular pattern for each line width. Then, the width and the protrusion amount of the application range of the surfactant which corresponds to the text pattern which has been selected is stored in a storage device of the computer 110 or a memory 11 of the printer 1 by being input into the computer 110.

Due to the checking process above, a table where the line width and the width and the protrusion amount of the application range of the surfactant correspond is stored in the storage device of the computer 110 or the memory 11 of the printer 1. In a case where the increased thickness phenomenon is different when the type of medium is different, a table may be further prepared for each type of medium.

Here, the selection method of the optimal test pattern is not limited to sensory checking according to the checker.

For example, the thickness of the rectangular pattern may be detected and the optimal test pattern may be selected based on the detection result. It is possible to use the non-stop CNC image measurement unit Quick Vision Streamplus manufactured by Mitutoyo Corporation which is used in the measurement of FIG. 1B in the measurement of the thickness of the rectangular pattern. Then, it is possible to select the optimal rectangular pattern with no increased thickness feeling if the rectangular pattern where the edge periphery is not more raised than the other portions as in the position A of FIG. 1B or the test pattern where the largest thickness of the edge periphery is in a predetermined range with the average thickness of the other portions as a reference is selected from among each of the measurement results of the plurality of rectangular patterns. In a case where the optimal test pattern is selected based on the measurement result of the thickness of the rectangular pattern, for example, the average value and dispersion (standard deviation) of a plurality of measurement points in the edge periphery are determined and the optimal test pattern may be selected based on the average value and the dispersion.

In addition, as another selection method, the mirror reflection light from the rectangular pattern is detected and the width of the line where the mirror reflection light is detected may be measured. That is, the rectangular pattern with no increased thickness feeling may be selected based on the measurement values of the width of the lines with mirror reflection light as shown in FIG. 2B.

The checking process described above may be performed in the manufacturing process of the printer 1 or may be performed by the user of the printer 1.

### Printing Process

When the user of the printer 1 specifies printing of the image which is drawn in the application program, the printer driver of the computer 110 is activated. The printer driver receives the image data from the application program, the image data is converted to printing data with a format which is able to be read by the printer 1, and the printing data is output to the printer. When the image data from the application program is converted into the printing data, the printer driver performs resolution conversion processing, color conversion processing, half tone processing, and the like. In addition, the printer driver of the embodiment performs preprocessing image generation processing for generating printing data for discharging the surfactant.

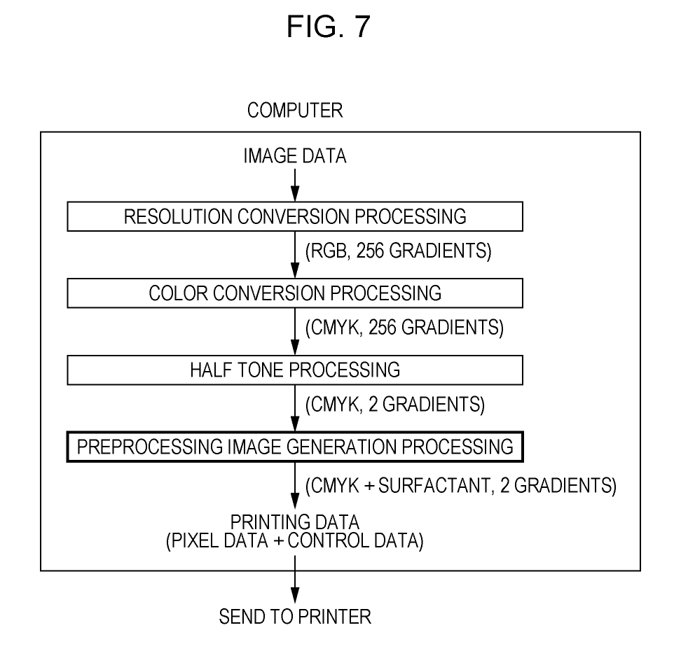

FIG. 7 is an explanatory diagram of functions of the printer driver of the computer 110.

The resolution conversion processing is processing which converts the image data which is output from the application program (text data, image data, and the like) to resolution which is printed on the medium (printing resolution). For example, in a case where the printing resolution is specified as 720×720 dpi, the image data with a vector format which is received from the application program is converted to the image data with a bitmap format with a resolution of 720×720 dpi. Each piece of pixel data in the image data after the resolution conversion processing is RGB data with multiple gradients (for example, 256 gradients) which is expressed in an RGB color space.

The color conversion processing is processing which converts the RGB data to the CMYK data which is expressed using CMYK color space. Here the CMYK data space is data which corresponds to the color of the ink in the printer. The color conversion processing is performed based on the table where the gradient value of the RGB data and the gradient value of the CMYK data correspond (a color conversion look up table LUT). Here, pixel data after the color conversion processing is a CMYK data with 256 gradients which is expressed in the CMYK color space.

The half tone processing is processing which converts the data with a high gradient number to data with a gradient number which the printer is able to form. For example, due to the half tone processing, the data which indicates 256 gradients is converted to one-bit data which indicates two gradients. In the image data after the half tone processing, the one-bit pixel data corresponds to each pixel. The one-bit pixel data is data which indicates the presence or absence of a dot. Here, the pixel data may be two-bit data and may indicate not only the presence or absence of the dot but also the size of the dot. In either case, the pixel data after the half tone processing is data which indicates the dot which is to be formed on the medium.

The preprocessing image generation processing is processing which generates printed data for applying the surfactant in the surroundings of the printed image as shown in FIG. 3A and FIG. 3C.

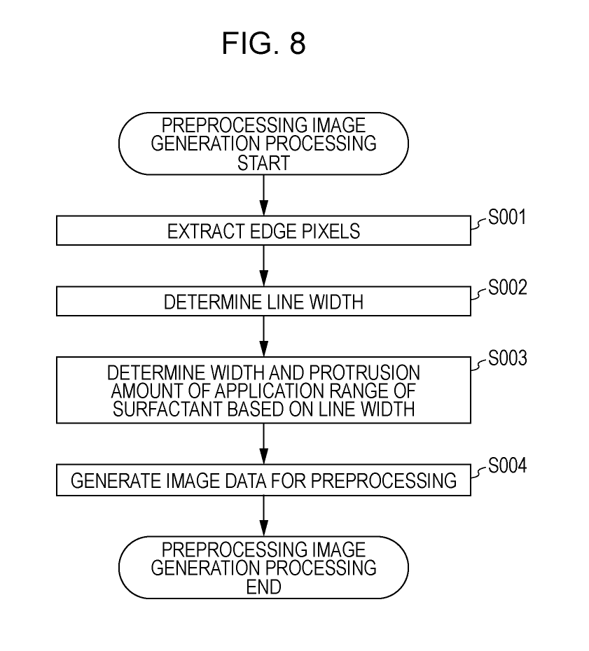

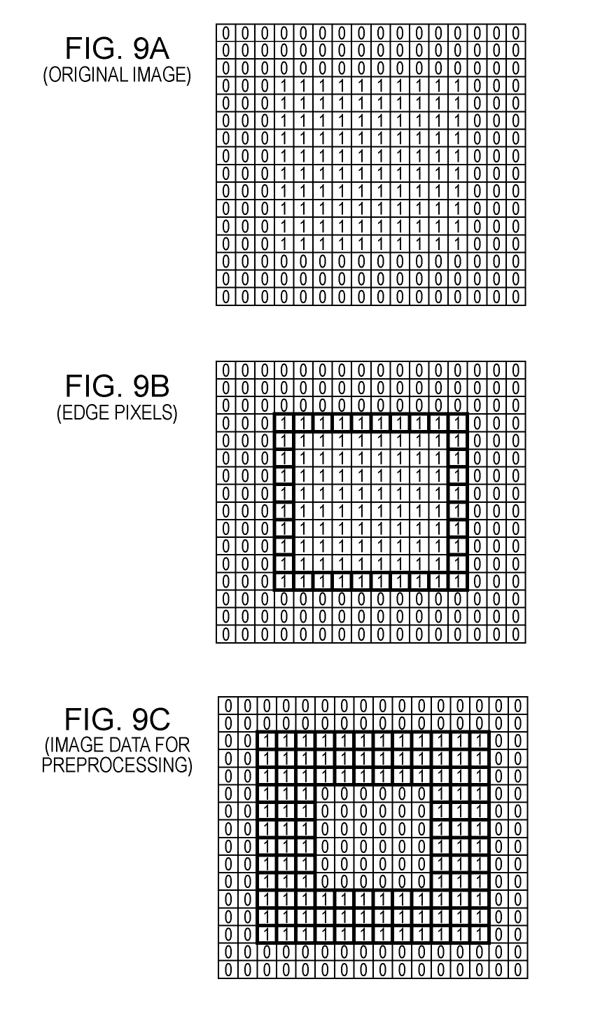

FIG. 8 is a flow diagram of the preprocessing image generation processing of FIG. 7. FIGS. 9A to 9C are explanatory diagrams of the image data. FIG. 9A is an explanatory diagram of the image data after the half tone processing. Here, one-bit pixel data corresponds for each pixel. Here, the UV ink is discharged based on the image data which is shown in FIG. 9A, the dots are formed by the UV ink being discharged in the pixels where the pixel data is “1”, and the UV ink is not discharged and the dots are not formed in the pixels where the pixel data is “0”. In addition, the covering image with 10×10 pixels is included in the image data. Here, only black image data will be described in order to simplify the description.

The printer driver carries out edge extraction processing with regard to the image data after the half tone processing (reference to FIG. 9A) and the edge pixel which is positioned in the contours of the image is extracted (FIG. 8: S001). Here, the pixels which are shown by the thick frame in FIG. 9B are extracted as the edge pixels.

Next, the printer driver determines the line width of the image based on the interval of the edge pixels in the X direction or the Y direction (FIG. 8: S002). Here, the printer driver determines that the line width is 10 pixels based on the interval of the edge pixels which are shown by the thick frame of FIG. 9B. Here, in a case where the interval of the edge pixels in the X direction (horizontal direction in the diagram) and the Y direction (vertical direction in the diagram) are different, the line width is determined based on the narrower interval. This is because the line width is erroneously determined in processing where the line width is determined based on the wider interval in a case where, for example, the image is lines which are long in the horizontal direction.

Next, the printer driver determines the width and the protrusion amount of the application range of the surfactant based on the line width (FIG. 8: S003). In the checking processing described above, since the table where the line width and the width and the protrusion amount of the application range of the surfactant correspond is stored in the computer 110, the printer driver determines the width and the protrusion amount of the application range of the surfactant based on the table. Here, it is determined that the width of the application range of the surfactant is “3” and the protrusion amount is “+1”.

Next, the printer driver generates the image data for preprocessing according to the width and the protrusion amount of the application range of the surfactant which has been determined (FIG. 8: S004). Here, since the width of the application range of the surfactant is “3” and the protrusion amount is “+1”, the pixels which are shown by the thick frame in FIG. 9C are pixels where the surfactant is discharged. As shown in the diagram, the pixel data “1” which indicates dot formation corresponds to the pixel which is indicates by the thick frame and the pixel data “0” which indicates no dot formation corresponds to the pixels other than this. In this manner, other than the image data for discharging the UV ink, the printer driver generates the image data for preprocessing for discharging the surfactant.

The computer 110 generates printing data by adding control data to the image data which is formed from pixel data with two gradients and sends the printing data to the printer 1 (refer to FIG. 7). The printer 1 which receives the printing data prints the image on the medium by controlling each of the units according to the control data which is included in the printing data, discharging the surfactant from each of the nozzles of the preprocessing head group 32 according to the image data for preprocessing (refer to FIG. 9C), and discharging the UV ink from each of the nozzles of the printing head group 31 according to the image data for the UV ink discharging (refer to FIG. 9A).

The printer 1 applies the surfactant to the application range (carries out preprocessing) as shown in FIG. 3A and FIG. 3C due to the discharging of the surfactant from each of the nozzles of the preprocessing head group 32 according to the image data for preprocessing (refer to FIG. 9C) while the medium S is being transported. Here, the surfactant is applied to the application range with the width as three pixels and the protrusion amount with regard to the edge of the printed image as +1 pixel.

After the application of the surfactant, the printer 1 applies the UV ink to the range which is covered with black in FIG. 3B and FIG. 3C due to the discharging of the UV ink from each of the nozzles of the printing head group 31 according to the image data for the UV ink (refer to FIG. 9A) while the medium S is being transported. Due to this, the printed image is printed on the medium. In the surroundings of the printed image, the UV ink is applied on where the surfactant has been applied.

Then, the printer 1 irradiates ultraviolet rays from the provisional curing irradiation section 41 and the main curing irradiation section 42 to the image. Due to this, the image which is formed by the UV ink is cured and the printed image is fixed to the medium.

According to the embodiment, due to the surfactant being applied to the surroundings of the printed image, it is possible to suppress the condensation of the UV ink in the surroundings of the printed image and to suppress the increased thickness phenomenon. As a result, the increased thickness feeling when the printed image is viewed is suppressed.

### Another Embodiment

In the embodiment described above, the rectangular patterns are formed. However, the embodiment is not limited to this.

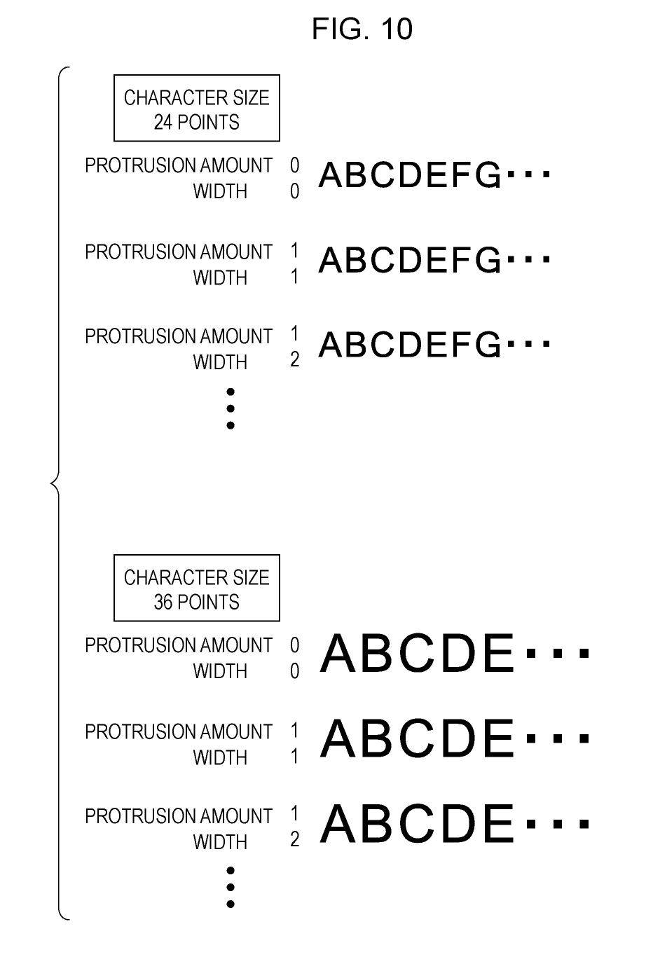

FIG. 10 is an explanatory diagram of another test pattern. In the embodiment, a character image is printed as the covering image instead of the rectangular pattern. In this manner, in the checking process, by the character image being printed on the medium and the increased thickness feeling and the image quality of the character image which has been printed being evaluated, an optimal value for the width and the protrusion amount of the range where the surfactant is applied may be determined. Here, in the same manner as the forming of the plurality of the test patterns with different line widths in the test patterns described above, it is desirable that a plurality of test patterns with character sizes which are different be formed in a case where the test pattern is formed using the character image. In this case, a table where the character size and the width and the protrusion amount of the range where the surfactant is applied correspond is stored.

### Other Embodiments

The embodiments described above are for easily understanding the invention and are not to be interpreted as limiting the invention. It is needless to say that the invention includes modifications and improvements which do not depart from the gist thereof and the equivalents of the invention.

### Covering Image

The covering image in the image data after the half tone processing described above is an image where the dots are formed in all of the pixels. However, the covering image is not limited to this. The covering image may be an image with an object where a predetermined region of the medium is covered with the ink and a pixel where the dots are not formed in a portion thereof may be included.

### Line Printer

The printer 1 described above is a so-called line printer, and the medium is transported with regard to the head which is fixed and a dot row is formed on the medium along the transport direction. However, the printer 1 is not limited to a line printer. For example, the printer 1 may be a printer where a head is provided on a carriage which is able to move in a main scanning direction and may be a printer (a so-called serial printer) where a dot formation operation where a dot row is formed along the main scanning direction by the UV ink being discharged from the head during movement and a transport operation where the medium is transported are alternately repeated.

In a case of a serial printer such as this, it is possible to form dot rows with intervals which are narrower than the nozzle pitch. That is, it is possible for the printer resolution to be higher than the nozzle pitch. As a result, the resolution of the image data described above may not only be a resolution which is the same as the nozzle pitch but a resolution which is higher than the nozzle pitch.

### Processing of Computer 110

The computer 110 described above performs the resolution conversion processing, the color conversion processing, the half tone processing, the preprocessing image generation processing, and the like. However, a portion or all of the processing may be performed by the printer 1. In a case where the preprocessing image generation processing which is performed by the computer 110 is performed instead by the printer, the printer 1 itself is equivalent to the “printing apparatus” since it is possible to print the image where preprocessing has been carried out on the medium using the printer 1 itself.

The entire disclosure of Japanese Patent Application No. 2011-097395, filed Apr. 25, 2011 is expressly incorporated by reference herein.

What is claimed is:

1. A printing apparatus comprising:
an ink discharge nozzle which discharges photocurable ink which is cured when irradiated with light onto a medium;
a surfactant nozzle which discharges a surfactant which has a substance which improves the wetting properties of the photocurable ink; and
an irradiating section which irradiates the light onto the photocurable ink which has landed on the medium,
wherein a process of discharging the surfactant from the surfactant nozzle onto the medium, a process of discharging the photocurable ink onto the medium, and a process of curing the photocurable ink by irradiating the light from the irradiating section are performed so that the surfactant is applied in the surroundings of the application range of the photocurable ink when an image is printed on the medium due to the application of the photocurable ink.

2. The printing apparatus according to claim 1,
wherein the application range of the surfactant is determined according to the line width of the image.

3. The printing apparatus according to claim 2,
wherein the width of the application range of the surfactant is determined according to the line width.

4. The printing apparatus according to claim 1,
wherein a test pattern is printed on the medium and the application range of the surfactant is determined according to the checking result of the test pattern.

5. The printing apparatus according to claim 1,
wherein the image is printed on a medium where there is no ink absorbing layer.

6. A printing method, which uses an ink discharge nozzle which discharges photocurable ink which is cured when irradiated with light onto a medium, a surfactant nozzle which discharges a surfactant which has a substance which improves the wetting properties of the photocurable ink, and an irradiating section which irradiates the light onto the photocurable ink which has landed on the medium, the method comprising:
when an image is printed on the medium due to the application of the photocurable ink,
discharging the surfactant from the surfactant nozzle onto the medium so that the surfactant is applied in the surroundings of the application range of the photocurable ink;
discharging the photocurable ink onto the medium; and
curing the photocurable ink by irradiating the light from the irradiating section are performed.

7. A program which causes a printing apparatus, which is provided with an ink discharge nozzle which discharges photocurable ink which is cured when irradiated with light onto a medium, a surfactant nozzle which discharges a surfactant which has a substance which improves the wetting properties of the photocurable ink, and an irradiating section which irradiates the light onto the photocurable ink which has landed on the medium, to execute:
when an image is printed on the medium due to the application of the photocurable ink,
discharging the surfactant from the surfactant nozzle onto the medium so that the surfactant is applied in the surroundings of the application range of the photocurable ink;
discharging the photocurable ink onto the medium; and
curing the photocurable ink by irradiating the light from the irradiating section are executed.
